(19) United States
(12) Patent Application Publication
(10) Pub. No.: US 2010/0047557 A1
(43) Pub. Date: Feb. 25, 2010

(54) CERAMIC AND/OR POWDER-METALLURGICAL COMPOSITE SHAPED BODY AND METHOD FOR THE PRODUCTION THEREOF

(75) Inventors: Andreas Baumann, Dresden (DE); Reinhard Lenk, Dresden (DE); Tassilo Moritz, Freiberg (DE); Hans-Juergen Richter, Dresden (DE); Hartmut Walcher, Waldachtal (DE); Marko Maetzig, Haigerloch-Stetten (DE)

Correspondence Address: GREENBLUM & BERNSTEIN, P.L.C., 1950 ROLAND CLARKE PLACE, RESTON, VA, 20191, US

(73) Assignee: Fraunhofer-Gesellschaft zur Foerderung der angewandten Forschung e.V., Muenchen (DE)

(21) Appl. No.: 12/523,123

(22) PCT Filed: Jan. 7, 2008
(86) PCT No.: PCT/EP2008/050101

§ 371 Date: Sep. 16, 2009

(30) Foreign Application Priority Data
Jan. 15, 2007 (DE) 10 2007 003 192.2

(51) Int. Cl. B28B 23/00; B22F 7/06; B29C 45/16

(52) U.S. Cl. 428/325; 264/645; 264/267

(57) ABSTRACT

The invention relates to the field of ceramics and relates to composite molded articles, such are used, for example, for chip-removal tools. The object of the invention is to disclose composite molded articles that are free in the design of their surface and interface and can be produced in series production. The object is attained through ceramic and/or powder metallurgical composite molded articles comprising a green tape and an injection molded article. The object is further attained through a method in which a green tape is inserted into or placed onto a mold, and subsequently at least one ceramic and/or powder metallurgical injection molding mass is placed on and/or applied to and/or inserted into the mold by means of injection molding, and subsequently the one-part or multi-part mold is removed and/or the one-part or multi-part composite molded part parts are removed from the mold, wherein these process steps can be repeated once or several times.

The invention relates to the field of ceramics and powder metallurgical materials and relates to a composite molded article, such as is used, for example for chip-removal tools (combination of hard brittle and ductile properties), heating elements and thermally loaded instruments (combination of electrically conducting and electrically insulating materials) or for products in dental technology (combination of material properties and optical properties) and a method for the production thereof.

Powder injection molding is a shaping method in which a feedstock comprising ceramic and/or metallic powders and organic plasticizing agents is injected into a cavity in the thermoplastic state and after the solidification takes on the geometric shape of the cavity. After a debinding process following the shaping, the final dimensions and properties of the component to be produced are produced in a final sintering process. Manifold advantages due to material and method, such as, e.g., the high inherent stiffness of ceramic materials, achievable surface finishes without reworking, and geometric freedom of design and complexity are utilized in the injection molding of ceramic. The cost factors of material, sintering and processing can thus be substantially reduced. As advantages in terms of process engineering, the injection molding process has a high mold complexity and freedom in the mold design. For example, undercuts, sharp edges and bores standing perpendicular to one another can be produced. Furthermore, a production of components with close to final contours can be carried out, which also show a virtually isotropic shrinkage during sintering. A very high material utilization is carried out, since the green parts and lugs can be recycled or used in the production of hot runner nozzles. The entire injection molding process can also be automated well.

Due to these advantages, the powder injection molding process has also been well examined scientifically in its application on a miniaturized scale. Components in submillimeter dimensions and detail dimensions in the nm range are produced here through the use of very fine-grain steel powders and ceramic powders (Benzler, T., Piotter, V.: MicroMIM und MicroCIM. Ingenieur-Werkstoffe 8 (1999), 16-17). The aspect of miniaturized component production was expanded with the aspect of the multifunctionalization of the same with the example of a heated needle, comprising very different conductive ceramics. The extremely small dimensions of the surface(s) to be joined are particularly advantageous here, so that the sinter dynamics inherent to the joining partners cause an extremely low absolute deviation in amount and rate (Finnah, G., Örlygsson, G., Piotter, V., Ruprecht, R., Hausselt, J.: Drei Sonderverfahren in einem, 2K-Mikro-Pulverspritzgieβen. Kunststoffe 1. Carl Hanser Verlag (2005), 58-61).

Furthermore, there have recently been increased developments in multi-component powder injection molding. As a requirement for obtaining sinter-stable ceramic and/or metal molded articles, strategies were formulated for material selection and formulation, processing and co-sintering. Particularly the different sintering shrinkage amounts and rates of the material partners to be combined have to be coordinated with one another by equalization of the relative particle packing densities and through the adjustment of the heat treatment step for the common debinding and sintering (Loibl, H., Bleier, H., Gornik, C., Griesmayer, E., Kukla C., Zlatkov, B.: 2-Komponenten-Pulverspritzgieβen, Österrr. Kunststoff-Zeitschrift 34 (2003), 258-260). Multi-component powder injection molding is becoming established in manifold process variants. Thus it has been shown that metallic joining partners combined with one another can also remain moveable with respect to one another after the sintering (so-called assembly powder injection molding) (Maetzig, M., Walcher, H.: Assembly moulding of MIM materials. Proceedings EuroPM2006 Vol. 2 (2006), 43-48). Another well examined process variant is sandwich powder injection molding. Taking into account a core-shell aspect, here the joining partners are sprayed with one another into the tool mold such that a component completely coated with the joining partner is always produced. In this manner, e.g., metal gear wheels with wear-resistant stainless steel coating were produced. (Alcock, J. R., Logan, P. M., Stephenson, D. J.: Surface engineering by co-injection moulding. Surface and Coatings Technology 105 (1998), 65-71).

Multi-component powder injection molding has further advantages in addition to the advantages of powder injection molding. The geometry of the component composed of several materials is relatively independent of the shape of the interface between the individual materials. The different materials do not have to lie one above the other as layers of uniform thickness either, i.e., in the production of the outer layer there is no compulsion to follow the contour of the interface. For example, independent and at the same time complicated shaped bodies can be produced thereby. Nevertheless, of course the production of layers and there in particular the production of very thick layers (>0.5 mm) with a freely selectable layer thickness ratio is also possible. Material composites with a closed porosity can also be produced with multi-component powder injection molding, whereby components of this type become useable in reactive media. Or, however, a desired proportion of closed porosity can be adjusted during sintering. The particularly cost-intensive high-performance materials can thus be locally limited to the locations in the component that are actually stressed, without impairing the properties for the entire molded article.

The disadvantages of multi-component powder injection molding according to the prior art lie in the high expenditure and in its complexity in the development and production of the tools and in its limits based on the realization of very large aspect ratios (layer thicknesses <0.5 mm) in the component.

Film casting is the preferred ceramic shaping technology for producing large-area, thin ceramic layers. The ceramic base powders are processed homogeneously together with a dispersing liquid, a liquefier and one or more binder components to form a film casting slip. The air-bubble-free slip is then fed to the casting station and distributed on the level casting base by a casting doctor blade set exactly at a specific height. In the following drying process the dispersing liquid is expelled uniformly, wherein the height of the film is reduced. If several layers are cast one above the other, this is called a multilayer film casting.

In the processing of the film casting slip, first the ceramic powder is dispersed together with a liquefier in the selected liquid. Subsequently, binder, plasticizer and wetting agent are added. The finished slip must be deaerated well before the casting in order to avoid the formation of bubbles. As a rule the ceramic slip is cast from a container onto a carrier film. This carrier film is generally guided past the container continuously. However, methods with a moved container also exist. A ceramic layer forms on the carrier film, which layer is dried in a drying tunnel and forms a self-supporting flexible ceramic film. The thickness of the layer is controlled via the exit gap height of the container and the height of the doctor blade. Hot air is blown counter-current over the film for drying so that a flexible green tape is present at the end of the belt. This can be wound up or further processed directly by cutting, punching, embossing or the like.

The strength and flexibility of the ceramic film depend essentially on the composition of the slip and in particular on the binder. Polymers soluble in water, polymers dispersible in water, polymers soluble in organic solvents, polymers dispersible in organic solvents can be used as a binder. The flexibility of the green tapes can be influenced additionally with the referenced binder through the addition of a plasticizer.

With continuous film casting, high production capacities can be achieved. The method is suitable for film thicknesses in the range of 0.05 mm-1.5 mm. Through lamination, individual films can be finished to form layer composites, so the film casting technology as a whole is characterized by a high flexibility.

As is known, multiple-part components of ceramic and/or powder metal are produced by injection molding as well as by film casting. DE 196 52 223 A1 describes a composite molded article produced by thermoplastic shaping, which comprises at least two ceramic and/or powder metallurgical materials and at least one thermoplastic binder and is characterized in that partial volumes are present inside the molded article, which have different material compositions and/or which have a different content of particles of the material/materials in the thermoplastic or thermosetting binder.

US 2003/0062660 describes the production of molded parts comprising two or more components via multi-component powder injection molding produced from ceramic and/or metallic powder materials.

The expenditure in terms of tool technology and mechanical engineering in the realization of a composite molded article with, for example, more than three parts in one component purely by powder injection molding, however, can be regarded as economically reasonable only to a qualified extent. The degree of specialization in terms of production engineering, together with correspondingly high tool and system costs can be suitable for a flexible use in practice only in individual cases.

The object of the invention lies in disclosing ceramic and/or powder metallurgical composite molded articles that are free in the design of their surface as well as in the design of the interface or of the boundary area between two materials of the composite molded article and are restricted only by the general disadvantages of the ceramic and/or powder metallurgical film production and injection molding methods, and in disclosing a simple, flexible and cost-effective method for the production thereof, which can also be used in series production.

The object is attained through the invention disclosed in the claims. Advantageous embodiments are the subject matter of the subordinate claims.

The ceramic and/or powder metallurgical composite molded articles according to the invention comprise a green tape or a green tape laminate of at least one ceramic and/or metallic and/or binder material, which covers the surface of the composite molded article completely or partially with the same and/or different composition and/or layer thickness or is contained in the composite molded article, and comprise a ceramic and/or metallic injection molded article, which is connected to the green tape or the green tape laminate at least in a positive manner, wherein the grain size and the grain distribution and/or the packing density of the ceramic and/or metallic powder grains in the green tape or the green tape laminate and the shrinkage behavior thereof during sintering is adjusted to the shrinkage behavior of the ceramic and/or metallic injection molded article in the subsequent sintering, and wherein in the case of the use of a thermoplastic binder in the green tape or in the green tape laminate, the melting and processing temperature of the injection molding material is lower than the melting temperature of the thermoplastic binder.

Advantageously, the green tape or the green tape laminate of the same or different material composition cover a ceramic and/or metallic injection molded article on the outer surface thereof completely and/or they are arranged in cavities or undercuts of a single-part or multi-part injection molded article, wherein even more advantageously green tapes or green tape laminates of different composition are used.

Likewise advantageously the interface or the interface area between the green tape or the green tape laminate and the injection molded article have the same geometric shape as the outer surface of the green tape or of the green tape laminate.

Furthermore advantageously, the green tape or the green tape laminate and the injection molded article are connected to one another in a non-positive manner or via chemical and/or physical bonds.

Also advantageously, the green tape or the green tape laminate contains a thermosetting binder.

And also advantageously, the green tape or the green tape laminate contains a thermoplastic binder, even more advantageously a polyethylene copolymer.

It is also advantageous if the green tape or the green tape laminate of the same and/or different layer thickness cover a ceramic and/or metallic injection molded article on the outer surface thereof and/or in cavities or undercuts of a one-part or multi-part injection molded article.

It is also advantageous if the green tape or the green tape laminate has a structuring completely or partially on one or on both surfaces, wherein even more advantageously the structuring contains further other materials and also advantageously the structuring contains polymers or natural materials.

It is furthermore advantageous if glass or glass-like materials are present as fillers in the green tape or in the green tape laminate and/or in the injection molded article.

It is likewise advantageous if the outer surface has a green tape of a metallic material, beneath that a green tape of a metallic and ceramic material is arranged, which is then followed by a ceramic injection molded article.

And it is also advantageous if a binder of the same composition is present in the green tape as well as in the entire green tape laminate and in the injection molded article.

It is also advantageous if a binder is present in the same quantity per volume unit in the green tape as well as in the entire green tape laminate and in the injection molded article.

And it is furthermore advantageous if a binder is present in the green tape as well as in the entire green tape laminate which corresponds with respect to the composition to that which is contained at least proportionally in the injection molded article and there is the last binder to be expelled from the injection molded article.

With the method according to the invention, a green tape or a green tape laminate of at least one ceramic and/or metallic and/or binder material is inserted into or placed onto a mold, wherein the mold is covered entirely or in part with green tape or green tape laminate of the same and/or different composition and/or the same and/or different layer thickness, and subsequently at least one ceramic and/or powder metallurgical injection molding mass is applied to and/or placed on and/or inserted into the mold by means of injection molding, and subsequently the one-part or multi-part mold is removed and/or the one-part or multi-part composite molded part parts are removed from the mold, wherein these process steps can be repeated once or several times.

Advantageously a pre-molded green tape or green tape laminate, even more advantageously punched, embossed, curved, drawn green tape or green tape laminates are used.

Likewise advantageously, a pre-molded green tape or green tape laminate with a carrier film is used.

Also advantageously, the mold for producing the pre-molded green tape or the green tape laminate is subsequently used as an injection molding mold, wherein even more advantageously a dividable mold is used.

Furthermore advantageously, a green tape laminate comprising different materials is used.

And also advantageously, a green tape or a green tape laminate is used that comprises partial areas of different material.

It is advantageous if the injection molding mass is placed and/or applied and/or inserted in a batchwise manner.

It is likewise advantageous if after placement and/or application and/or insertion of an injection molding mass on and/or to and/or in a mold with at least one green tape or a green tape laminate, this composite molded article is removed from the mold, subsequently one or more further green tapes or green tape laminates are placed on and/or applied to and/or inserted into the composite molded article and these process steps are repeated several times.

It is also advantageous if an injection molding mass is placed on, applied to, or inserted into a green tape or a green tape laminate.

It is furthermore advantageous if the filling and/or the spraying and/or injection of the mold is carried out under pressure or by means of a vacuum.

It is also advantageous if a thermoplastic and/or thermosetting and/or biopolymer binder is used as a binder for the green tapes or green tape laminates.

It is likewise advantageous if the green tape or the green tape laminate is deformed during the application, placement or insertion of the injection molded article.

It is furthermore advantageous if a binder is inserted in the green tape or in the green tape laminate, which binder is inserted at least proportionally in the injection molded article and which is the last to be expelled from the composite molded article.

And it is also advantageous if the composite molded article is debinded and sintered.

It is also advantageous if the filling of the injection molding mass(es) into a mold, or the spraying of the injection molding mass(es) onto a film is carried out under a pressure of 0.3 to 200 MPa.

The advantage of the solution according to the invention lies in the simplified tool technology, in the possibility of realizing thin structural and/or functional layers even over large areas and paths and thus, for example, prefabricating miniature components to be segregated over large areas, cost-effectively and effectively. Another advantageous aspect of the solution according to the invention is a simplified process technology. Ceramic and/or powder metallurgical green tapes or green tape laminates can be produced in different layer thicknesses and can be processed by subsequent processes, for example, embossed, punched, microstructured, screen printed or laminated, wherein, for example, intermediate layers can also be applied.

If the green tapes or green tape laminates are placed in an injection molding tool, for example, these tapes can assume the geometric and/or surface shape of the injection molding tool, whereby even extremely filigree structures and contours can be produced.

Also the process control can be designed through the selection of suitable powders and binder systems such that the composite molded article according to the invention produced according to the invention can be sintered in one step.

The equalization of the sintering shrinkage behavior of the components of the composite molded article thereby takes place through the adjustment of the relative particle packing densities of the composite partners depending on the achievable absolute sintering compaction during co-sintering. That means that material composites in terms of the composite molded article according to the invention, which cannot be completely densely sintered within a temperature window because either the sintering temperature is too low for one partner or the particle size distributions of the powders of the composite partners differ too much in size, can be adjusted to a common sintering shrinkage amount through the selection of asymmetrical relative particle packing densities. To this end, the so-called space holder method can also be used, in which powder particles are substituted in part by organic fillers in order to achieve an increased sintering shrinkage or increased residual porosity after sintering.

Through the solution according to the invention the possibilities for multi-component shaping of material composite components are drastically expanded and the ability for series production is achievable in that the powder injection molding process remains reduced to one component. In particular the integration of thin functional layers into a corresponding multi-part component through the spraying of green tapes filled with ceramic and/or metallic powder materials with ceramic and/or metallic feedstocks represents an advance into new production dimensions, which cannot be achieved technically or financially with conventional multi-component powder injection molding.

With the solution according to the invention a composite strategy is realized which makes it possible to produce an active and/or passive material composite in the joint zone. Active material composites are characterized by the chemical correspondence (chemical bonding) of the materials combined with one another or of individual constituents of the material composite (doping, elements, phases). Here covalent and/or ionic bonds produce the composite strength in the joint zone.

Passive material composites are determined by geometric modifications (for example, undercuts, toothings, mechanical interlockings) and/or by variation of the by powder packing density and powder particle size and by the macroscopic surface structure (rough, structured) of the interfaces and/or the interface area of the joint zone. Here mechanical forces produce the composite strength in the joint zone.

The composite molded article according to the invention can be described by two strategies independent of one another which complement one another. Active composites can be achieved directly through the combination of at least two materials that are compatible with respect to their material affiliation without intermediate layers in the joint zone or indirectly through mixing (graduated systems) materials of different classes and use thereof as an adhesion promoter between the respectively foreign materials (intermediate layers). Foreign components can also be used as adhesion promoter and realize an active material composite.

Passive composite molded articles have material combinations which do not interact or hardly interact at all with respect to a chemical bond and essentially can be bonded through their geometric shaping in the joint zone. This can be carried out, for example, through the injection into one another of the materials to be combined. Pencil-shaped overmoldings becoming wider towards the structural partner can form a clamp-like composite. According to the invention, this can be achieved, for example, by filling perforated film areas during injection molding. Through the lamination or placement one above the other of at least two films, the perforated areas can be designed variably deep and flat. so that one or more material anchors becoming wider in the injection direction are formed.

With respect to the material combinations and binder systems used, the present invention essentially can be freely selectable, but the process control should be taken into consideration.

It is particularly advantageous if binder systems are used that are contained in the green tape or in the green tape laminate as well as in the injection molding material. The expulsion of the binder is thereby much simpler and improved.

If different binders are used, a particular advantage of the invention is when the green tape or the green tape laminate are produced with so-called backbone binders which are at least one constituent of the binder of the injection molding material. These binder systems take a long time to be expelled. The more easily expelled binder portions present in the injection molded part can thereby escape first, and the green tape or the green tape laminate still remains elastic. The portions in the green tape or in the green tape laminate escape too only when the backbone binder portions of the injection molding material are expelled, and the debinding as a whole is completed. Such backbone binders are for example polyolefins such as polyethylene or polyethylene copolymer.

The invention is explained in more detail below based on an exemplary embodiment.

### EXAMPLE 1

Sinterable composite molded articles of steel film and ceramic feedstock:

Steel film (fullness (dry) 60% by volume):

Powder: Steel 430L; d₉₀=16 μm; manufacturer: Sandvik Osprey Ltd.

Ceramic feedstock (fullness: 60% by volume):

Powder: ZrO₂ (3 mol % Y) type Y5-5; d₈₀=1.97 μm; manufacturer: United Ceramics Ltd.

To produce a film, a slip is produced composed of organic solvents (90% by mass hexane, 9% polyethylene copolymer, 1% alkyl succinimide) and filled with 85% by mass steel powder 430L. The homogenization of the suspension is carried out with the aid of milling balls on the roller mill. An ultrasonic treatment (2×30 s) helps to destroy the powder agglomerates in the slip. The well homogenized slip is poured on a film casting apparatus (doctor blade method) and dried. The dried steel film (thickness 500 μm, width 20 cm, length 1 m) is removed from the casting base and finished geometrically such that it can be inserted into the profile of the mold cavity of the injection molding tool and sprayed with a ceramic feedstock. To produce the feedstock, as a ceramic powder ZrO₂ type Y5-5 (92% by mass) is mixed with a thermoplastic binder (45% paraffin, 45% LD polyethylene, 10% stearic acid) under the effect of temperature (130° C.) and of shear energy on a shear roller compactor (for 1 h). The homogenized powder-binder mixture is granulated and in this form fed to the injection molding process. Subsequently a common debinding (100 h under air atmosphere up to 400° C. with a heating rate of 6 K/h) and sintering (H₂ atmosphere 1450° C.) is carried out, during which the composite molded article is freed from the binder phase and with identical shrinkage amount is densely sintered to approximately the material densities corresponding to the joining partners.

After the sintering treatment a thermal shock-resistant steel-ceramic composite is obtained which has at least a strength of 1 MPa. With a grinding preparation of the joint zone, a continuously closed composite zone can be discerned under the electron microscope.

The boundary surface between film and injection molding reproduces the surface geometry of the cavity into which the film was placed.

1. Ceramic and/or powder metallurgical composite molded article comprising a green tape or a green tape laminate of at least one ceramic and/or metallic and/or binder material, which covers the surface of the composite molded article completely or partially with the same and/or different composition and/or layer thickness or is contained in the composite molded article, and comprising a ceramic and/or metallic injection molded article, which is connected to the green tape or the green tape laminate at least in a positive manner, wherein the grain size and the grain distribution and/or the packing density of the ceramic and/or metallic powder grains in the green tape or the green tape laminate and the shrinkage behavior thereof during sintering is adjusted to the shrinkage behavior of the ceramic and/or metallic injection molded article in the subsequent sintering, and wherein in the case of the use of a thermoplastic binder in the green tape or in the green tape laminate, the melting and processing temperature of the injection molding material is lower than the melting temperature of the thermoplastic binder.

2. Composite molded articles according to claim 1, in which the green tape or the green tape laminate of the same or different material composition a ceramic and/or metallic injection molded article on the outer surface thereof and/or in cavities or undercuts of a one-part or multi-part injection molded article are arranged, and completely cover it or are arranged inside an injection molded article.

3. Composite molded articles according to claim 2, in which the green tape or the green tape laminate of different composition completely covers the outer surface and the surface of cavities and undercuts of a multi-part injection molded article.

4. Composite molded articles according to claim 1, in which the interface or interface area between the green tape or the green tape laminate and the injection molded article has the same geometric shape as the outer surface of the green tape or of the green tape laminate.

5. Composite molded articles according to claim 1, in which the green tape or the green tape laminate and the injection molded article are connected to one another in a non-positive manner or via chemical and/or physical bonds.

6. Composite molded articles according to claim 1, in which the green tape or the green tape laminate contains a thermosetting binder.

7. Composite molded articles according to claim 1, in which the green tape or the green tape laminate contains a thermoplastic binder.

8. Composite molded articles according to claim 7, in which the green tape or the green tape laminate contains a polyethylene copolymer.

9. Composite molded articles according to claim 1, in which the green tape or the green tape laminate of the same and/or different layer thickness cover a ceramic and/or metallic injection molded article on the outer surface thereof and/or in cavities or undercuts of a one-part or multi-part injection molded article.

10. Composite molded articles according to claim 1, in which the green tape or the green tape laminate has a structuring completely or in part on one or both surfaces.

11. Composite molded articles according to claim 10, in which the structuring contains further other materials.

12. Composite molded articles according to claim 11, in which the structuring contains polymers or natural materials.

13. Composite molded articles according to claim 1, in which glass or glass-like materials are present as fillers in the green tape or in the green tape laminate and/or in the injection molded article.

14. Composite molded articles according to claim 1, in which the outer surface has a green tape of a metallic material, beneath that a green tape of a metallic and ceramic material is arranged, which is then followed by a ceramic injection molded article.

15. Composite molded article according to claim 1, in which a binder of the same composition is present in the green tape as well as in the entire green tape laminate and in the injection molded article.

16. Composite molded article according to claim 1, in which a binder is present in the same quantity per volume unit in the green tape as well as in the entire green tape laminate and in the injection molded article.

17. Composite molded article according to claim 1, in which a binder is present in the green tape as well as in the entire green tape laminate which corresponds with respect to the composition to that which is contained at least proportionally in the injection molded article and there is the last binder to be expelled from the injection molded article.

18. Method for the production of a ceramic and/or powder metallurgical composite material, in which a green tape or a green tape laminate of at least one ceramic and/or metallic and/or binder material is inserted into or placed onto a mold, wherein the mold is covered entirely or in part with green tape or green tape laminate of the same and/or different composition and/or the same and/or different layer thickness, and subsequently at least one ceramic and/or powder metallurgical injection molding mass is placed on and/or applied to and/or inserted into the mold by means of injection molding, and subsequently the one-part or multi-part mold is removed and/or the one-part or multi-part composite molded part parts are removed from the mold, wherein these process steps can be repeated once or several times.

19. Method according to claim 18, in which a pre-molded green tape or green tape laminate are used.

20. Method according to claim 19, in which a punched, embossed, curved, drawn green tape or green tape laminate are used.

21. Method according to claim 18, in which a pre-molded green tape or green tape laminate with a carrier film is used.

22. Method according to claim 18, in which the mold for producing the pre-molded green tape or the green tape laminate is subsequently used as an injection molding mold.

23. Method according to claim 22, in which a dividable mold is used.

24. Method according to claim 18, in which a green tape laminate comprising different materials is used.

25. Method according to claim 18, in which a green tape or a green tape laminate is used that comprises partial areas of different material.

26. Method according to claim 18, in which the injection molding mass is placed and/or applied and/or inserted in a batchwise manner.

27. Method according to claim 18, in which after placement and/or application and/or insertion of an injection molding mass on and/or to and/or in a mold with at least one green tape or a green tape laminate, this composite molded article is removed from the mold or the mold is removed, subsequently one or more further green tapes or green tape laminates are placed on and/or applied to and/or inserted into the composite molded article and these process steps are repeated several times.

28. Method according to claim 18, in which an injection molding mass is placed on and/or applied to and/or inserted into a green tape or a green tape laminate.

29. Method according to claim 18, in which the filling and/or the spraying and/or injection of the mold is carried out under pressure or by means of a vacuum.

30. Method according to claim 18, in which a thermoplastic and/or thermosetting and/or biopolymer binder is used as a binder for the green tapes or green tape laminates.

31. Method according to claim 18, in which the green tape or the green tape laminate is deformed during the application, placement or insertion of the injection molded article.

32. Method according to claim 18, in which a binder is inserted in the green tape or in the green tape laminate, which binder is inserted at least proportionally in the injection molded article and which is the last to be expelled from the composite molded article.

33. Method according to claim 18, in which the composite molded article is debinded and sintered.

34. Method according to claim 18, in which the filling of the injection molding mass(es) into a mold, or the spraying of the injection molding mass(es) onto a film is carried out under a pressure of 0.3 to 200 MPa.
